(19) United States
(12) Patent Application Publication
(10) Pub. No.: US 2013/0119667 A1
(43) Pub. Date: May 16, 2013

(54) JET ENGINE WITH CARBON CAPTURE

(71) Applicants: Tor Christensen, Sandefjord (NO); Knut Børseth, Sandefjord (NO); Stellan Hamrin, Kungsor (SE); Hermann De Meyer, Brasschaat (BE)

(72) Inventors: Tor Christensen, Sandefjord (NO); Knut Børseth, Sandefjord (NO); Stellan Hamrin, Kungsor (SE); Hermann De Meyer, Brasschaat (BE)

(21) Appl. No.: 13/811,753

(22) PCT Filed: Jul. 22, 2011
(86) PCT No.: PCT/EP2011/062652

§ 371 Date: Jan. 23, 2013

(30) Foreign Application Priority Data
Jul. 28, 2010 (NO) 20101079
Mar. 9, 2011 (NO) 20110359

(51) Int. Cl. F01N 3/08; F01K 23/10; H02K 7/18

(52) U.S. Cl. CPC F01N 3/0807; H02K 7/1823; F01K 23/10
USPC 290/52; 60/39.182

(57) ABSTRACT

A method for producing electrical power and capture CO₂, where gaseous fuel and an oxygen containing gas are introduced into a gas turbine to produce electrical power and an exhaust gas, where the exhaust gas withdrawn from the gas turbine is cooled by production of steam in a boiler (20), and where cooled exhaust gas is introduced into a CO₂ capture plant for capturing CO₂ from the cooled exhaust gas leaving the boiler (20) by an absorption/desorption process, before the treated CO₂ lean exhaust gas is released into the surroundings and the captured CO₂ is exported from the plant, where the exhaust gas leaving the gas turbine has a pressure of 3 to 15 bara, and the exhaust gas is expanded to atmospheric pressure after leaving the CO₂ capture plant. A plant for carrying out the method is also described.

### TECHNICAL FIELD

The present invention relates to the field of CO₂ capture from CO₂ containing gases, such as exhaust gases from combustion of carbonaceous fuels. More specifically, the invention relates to improvements to a gas fired power combined cycle power plant including CO₂ capture having a higher electrical efficiency compared to earlier proposed solutions.

### BACKGROUND ART

The release of CO₂ from combustion of carbonaceous fuels, and most specifically fossil fuels is of great concern due to the greenhouse effect of CO₂ in the atmosphere. One approach to obtain reduction of CO₂ emission into the atmosphere is CO₂ capture from the exhaust gases from combustion of carbonaceous fuels and safe deposition of the captured CO₂. The last decade or so a plurality of solutions for CO₂ capture have been suggested.

The technologies proposed for CO₂ capture may be categorized in three main groups:

1. CO₂ absorption—where exhaust gas is reversibly absorbed from the exhaust gas to leave a CO₂ lean exhaust gas and the absorbent is regenerated to give CO₂ that is treated further and deposited.

2. Fuel conversion—where hydrocarbon fuels are converted (reformed) to hydrogen and CO₂. CO₂ is separated from the hydrogen and deposited safely whereas the hydrogen is used as fuel.

3. Oxyfuel—where the carbonaceous fuel is combusted in the presence of oxygen that has been separated from air. Substituting oxygen for air leaves an exhaust gas mainly comprising CO₂ and steam which may be separated by cooling and flashing.

WO 2004/001301 A (SARGAS AS) 13 Dec. 2003, describes a plant where carbonaceous fuel is combusted under an elevated pressure, where the combustion gases are cooled inside the combustion chamber by generation of steam in steam tubes in the combustion chamber, and where CO₂ is separated from the combustion gas by absorption/desorption to give a lean combustion gas and CO₂ for deposition, and where the lean combustion gas thereafter is expanded over a gas turbine.

WO 2006/107209 A (SARGAS AS) 12 Oct. 2006 describes a coal fired pressurized fluidized bed combustion plant including improvements in the fuel injection and exhaust gas pre-treatment,

Combustion of the carbonaceous fuel under elevated pressure and cooling of the pressurized combustion gases from the combustion chamber reduces the volume of the flue gas, relative to similar amounts of flue gas at atmospheric pressure. Additionally, the elevated pressure and cooling of the combustion process makes a substantially stoichiometric combustion possible. A substantially stoichiometric combustion giving a residual content of oxygen of <5% by volume, such as <4% by volume or <3% by volume, reduces the mass flow of air required for a specified power production. The elevated pressure in combination with the reduced mass flow of air results in a substantial reduction of the total volume of the exhaust gas to be treated. Additionally, this results in substantial increase in the concentration and partial pressure of CO₂ in the flue gas, greatly simplifying the apparatus and reducing the energy required to capture CO₂. Furthermore, the low residual content of oxygen gives less oxygen in the CO₂ product, which is important for applications of the CO₂ such as for increased oil recovery from oil wells.

WO 99/48709 A, (Norsk Hydro AS), 24 Aug. 2000, relates to a power plant comprising a main power and secondary power system. The main power system is a combined cycle power plant comprising a gas turbine and a steam turbine where steam is generated by cooling the exhaust gas leaving the gas turbine. The cooled and expanded exhaust gas is then introduced into the secondary power system where the exhaust gas is compressed and again cooled before the compressed exhaust gas is introduced into an amine based CO₂ capture plant where the exhaust gas is separated in a CO₂ stream that is exported from the plant, and a CO₂ depleted stream that is reheated before the gas is expanded over a turbine for generation of electrical power before the expanded CO₂ depleted exhaust gas is released into the surroundings. By recompressing the exhaust gas after leaving the combined cycle power plant, the volume of the exhaust gas to be treated is substantially reduced, although not to the degree obtainable by substantially stoichiometric combustion. Additionally, the partial pressure of CO₂ of the exhaust gas is increased, which again increases the efficiency of the CO₂ capture in the absorption unit of the CO₂ capture plant.

The CO₂ capture process is an energy consuming process substantially reducing the overall efficiency of the power plant. Substantially effort has been made to reduce the energy, or heat loss, caused by the CO₂ capture process, as the energy loss is of great economical interest. This energy loss is an important bar for implementing CO₂ capture, and a reduction of the energy loss is therefore important for making CO₂ capture economically possible.

### SUMMARY OF INVENTION

According to a first aspect, the present invention relates to a method for producing electrical power and capture CO₂, where gaseous fuel and an oxygen containing gas are introduced into a gas turbine to produce electrical power and an exhaust gas, where the exhaust gas withdrawn from the gas turbine is cooled by production of steam in a boiler, and where cooled exhaust gas is introduced into a CO₂ capture plant for capturing CO₂ from the cooled exhaust gas leaving the boiler by an absorption/desorption process, before the treated CO₂ lean exhaust gas is released into the surroundings and the captured CO₂ is exported from the plant, wherein the exhaust gas leaving the gas turbine has a pressure of 3 to 15 bars, that the exhaust gas is expanded to atmospheric pressure after leaving the CO2 capture plant. By partially expanding the exhaust gas in the gas turbine to a pressure from 3 to 15 bara, the volume of the exhaust gas is higher and the pressure is higher than in a plant operating at substantially atmospheric pressure, without the need for costly flue gas re-compression. The lower volume and higher pressure gives several advantages. The reduced volume of the gas reduces the size requirement for the carbon capture equipment. The higher pressure of the exhaust gas increases the partial pressure of CO₂ and increases the efficiency and speed of the absorption process and thus the CO₂ capture. The higher pressure also makes it possible, in an efficient way, to use hot potassium carbonate based absorbents. Hot potassium carbonate based absorbents are stable and non-volatile and therefore environmentally friendly/acceptable in contrast to the different amines or ammonium carbonate absorbents that are used have been proposed for carbon capture plants.

The presently preferred pressure of the exhaust gas leaving the gas turbine is 6 to 12 bara. The pressure is a compromise between the preferred pressure for the carbon capture and the required expansion in the gas turbine to give power for the gas turbine compressor and a temperature of the expanded gas that may be cooled further in the boiler.

According to one embodiment, NOx in the exhaust gas is removed or substantially reduced after the exhaust gas is leaving the boiler, and before introduction into an absorber in the CO₂ capture plant. Introduction of a unit for NOx removal/reduction both reduces the emission of NOx from the power plant as such, and avoids problems with NOx in the carbon capture part of the plant.

According to another embodiment, the exhaust gas leaving the boiler is further cooled by heat exchanging against CO₂ lean exhaust gas leaving the absorber, and wherein the CO₂ lean exhaust gas thereafter is expanded over a turbine. The heat exchanging of the exhaust gas to be introduced into the absorber against the CO₂ lean exhaust gas leaving the absorber, reduces the temperature of the exhaust gas to be introduced into the absorber, which is an advantage for the absorption in the stripper. Additionally, heating of the lean exhaust gas to be expanded over the turbine for expansion of lean exhaust gas, adds energy to the gas to be expanded and thus the energy output from the turbine.

According to a second aspect, the present invention relates to a combined cycle power plant with CO₂ capture, comprising a gas turbine, a boiler for cooling of the exhaust gas leaving the gas turbine by generation of steam in heat tubes, a steam turbine cycle to produce electric power from the steam generated in the boiler, and a CO₂ capture plant comprising an absorber adopted to bring an aqueous absorbent in countercurrent flow to the exhaust gas to give CO₂ lean exhaust gas and a CO₂ rich absorbent, an lean exhaust line for withdrawal of the lean exhaust gas from the absorber, a rich absorbent line for withdrawing rich absorbent from the absorber and introducing the rich absorbent into a stripper for regeneration of the absorbent, a CO₂ withdrawal line for withdrawal of a CO₂ rich stream from the stripper, and a lean absorbent line for withdrawing regenerated, or lean, absorbent from the stripper and introducing the lean absorbent into the absorber, wherein the gas turbine is configured for partial expansion of the exhaust gas to a pressure of 3 to 15 bara, and wherein a turbine for expanding the exhaust gas to atmospheric pressure is arranged downstream of the absorber for expanding of the exhaust gas after capture of the CO₂.

### BRIEF DESCRIPTION OF DRAWINGS

FIG. 1 is a principle drawing of a first embodiment of gas fired power plant according to the present invention,

FIG. 2 is a principle drawing of a second embodiment according to the present invention,

FIG. 3 is principle drawing of a third embodiment according to the present invention, and

FIG. 4 is a principle drawing of a fourth embodiment of the present invention.

### DETAILED DESCRIPTION OF THE INVENTION

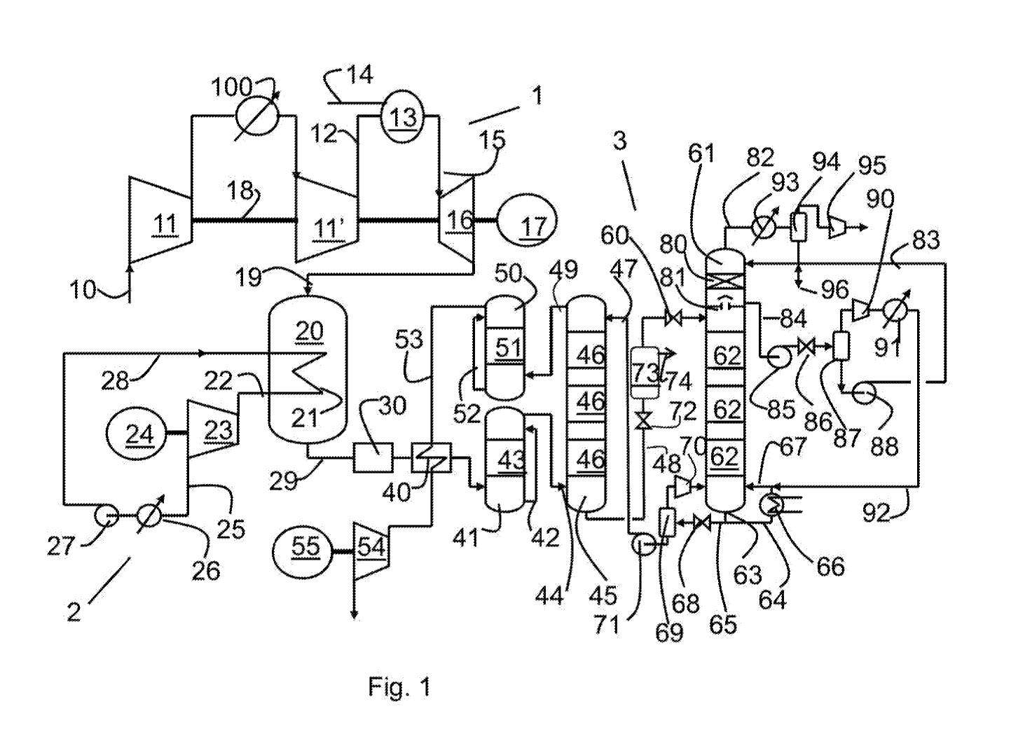

FIG. 1 is a representation illustrating the basic concept of the present invention. The illustrated plant comprises three main parts, a gas turbine 1, a steam turbine unit 2, and a CO₂ capture plant 3.

Air is introduced via an air line 10 into a compressor 11, 11′ with an intercooler 100 between the stages. The compressor may also be operated without intercooler 100. Compressed air is led via a line 12 and mixed with gas, such as natural gas, that is introduced in a fuel line 14 into a combustion chamber 13 where the gas is combusted under an elevated pressure. Typically, the pressure in the combustion chamber is in the range above 20 bar absolute, hereinafter abbreviated bara. High pressure up to above 40 bara is preferred. The combustion gas is withdrawn through a compressed exhaust line 15 and is introduced into a turbine 16, where the gas is partially expanded, from the pressure in the combustion chamber to a pressure of 3 to 15 bara, such as typically 6 to 12 bara.

Expansion of the exhaust gas reduces the temperature of the exhaust gas, and the degree of expansion is a compromise between the necessity of driving the compressor 11, 11′ and reducing the temperature of the exhaust gas sufficiently for the downstream equipment, and the preferred high pressure in the CO₂ capture unit. Expanding the pressure from typically 42 bara 1250° C. to 8.4 bara gives an outlet temperature of about 830° C., which is suitable for further external cooling by the production of steam. In contrast, the expansion from lower pressure turbines, which operate at typically 26 bara, will give much higher outlet temperatures. As an example, expanding the pressure from typically 26 beta 1250° C. to 8.4 bara will reduce the temperature of the exhaust gas to about 940° C. which would greatly complicate the further cooling by production of steam in an external apparatus.

The turbine 16 is connected to a generator 17 via an axle 18, for generation of electrical power. For efficient CO₂ capture, the pressure at the outlet from turbine 16 should be as high as possible. This is achieved when the power from turbine 16 is just sufficient to drive compressor 11. In this case, the power from generator 17 will be small or zero. In this case, generator 17 may be removed. The axle 18 is illustrated as one common axle for the compressor 11, turbine 16 and generator 17, but the skilled man will understand that special designs, not shown on the drawing, such as two axles, may be preferred to reduce the problem caused by imbalance at the axle due to the different flow in the compressor and turbine. Most commercially available gas turbines will not be able to handle this imbalance at the axle. The inventors have identified at least one specific gas turbine having the required properties and that may tackle such imbalance, namely LMS100 from GE Power Systems, Houston, USA.

The exhaust gas is withdrawn from the turbine 16 in an expanded exhaust line 19 and introduced into a boiler 20 where the exhaust as is cooled by generation of steam in heat tubes 21 inside the pressure container of the boiler 20. Exhaust line 19 may be a double pipe where the outer pipe is insulated and kept at a relatively low temperature such as 300 to 400° C., the annulus between the pipes is pressurized with a flowing gas such as air with a temperature of not more than 300 to 400° C., and the inner pipe is used for the hot exhaust gas. Boiler 20 may consist of a pressure container which is kept at a relatively low temperature, such as 300 to 400° C. for structural integrity, and an internal enclosure where the hot exhaust gas is brought in contact with the heat tubes 21. The low temperature of the pressure shell may be achieved by flowing air or a cold gas between the pressure shell and the internal heat tube enclosure, and/or by cooling the internal heat tube enclosure with water.

Steam is withdrawn from the boiler 20 though steam line 22, and is introduced into a steam turbine 23. The steam turbine 23 is connected to a second generator 24 for generation of electrical power.

Expanded steam is withdrawn from the steam generator 23 via an expanded steam line 25 and is cooled in a cooler 26 to ascertain that the steam is condensed. A circulation pump 27 is provided to pump the condensed steam, or water, through a water line 28 and back to the heat tubes 21 in the boiler 20. The skilled man will understand that preheating of the water, using waste heat or steam side draw from the steam turbine 23, and re-heat of the steam after partial expansion in steam turbine 23 before final expansion, will increase the efficiency of this cycle.

Partly expanded and partly cooled exhaust gas, at a temperature between 250 and 450° C. is withdrawn from the boiler through line 29.

Combustion of carbonaceous fuel in the presence of air generates NOx. Besides its environmental effects, NOx may also be detrimental to the CO₂ capture. A Selective Catalytic Reduction (SCR) unit 30 therefore arranged downstream of the boiler 20. Urea or NH₃ is introduced into the SCR unit and reacted with NOx over a catalyst for removal of NOx according to known technology. The temperature in the SCR unit is preferably between 250 and 450° C. Preferred operation temperature for a SCR unit is about 350° C. The SCR unit may be combined with a catalyst to oxidize CO to CO2.

Downstream of the SCR unit one or more heat exchangers, exhaust gas scrubbers and possibly filters are arranged. The first heat exchanger 40 is a flue gas cooling unit far cooling of the exhaust gas to below 250° C. The second illustrated coaling unit 41 is illustrated as a countercurrent scrubber, or combined direct contact cooler and polishing unit, which is the preferred cooler as it both cools and saturates the exhaust gas with water, and removes residual contaminants such as NOx and ammonia slip from the flue gas.

Cooling water is introduced into the cooler 41 through recirculation pipe 42 into the cooler 41 above a contact zone 43 and brought in counter-current flow to exhaust gas that is introduced into the cooler 41 below the contact zone. Water is collected at the bottom of the cooler 41 and recycled through the recirculation pipe 42. Recirculation pipe 42 may be routed via a heat exchanger to remove excess heat, such that the fluid flowing to the top of contact zone 43 is colder than at the bottom of the contact zone. Recirculation pipe 42 may alternatively be routed directly to the top of countercurrent scrubber 51, where it is cooled by contact with relatively dry gas from CO₂ absorber column 45, via line 49. Cooling occurs because some water is vaporized into the relatively dry gas. Circulation pipe 52 is then routed to the top of countercurrent scrubber 43. In this way, the flue gas temperature may be adjusted as required for the CO₂ absorber.

Cooled exhaust gas is withdrawn from the cooler 41 through a cleaned exhaust gas line 44 and is introduced into the lower part of an absorber column 45 where the exhaust gas is brought in counter-current flow with an aqueous absorbent in one or more contact zone(s) 46 inside the absorber. The aqueous absorbent is introduced into the absorber above the upper contact zone through a lean absorbent line 47.

CO₂ in the exhaust gas is absorbed by the absorbent inside the absorber to give a CO₂ laden, or rich, absorbent that is withdrawn from the bottom of the absorber 45 through a rich absorbent line 48.

A lean exhaust gas, from which more than 50%, preferred more than 80%, of the CO₂ in the exhaust gas introduced into the absorber is removed, is withdrawn through a lean exhaust gas line 49.

The pressure in the absorber is slightly lower than the pressure in the boiler 20 due to a minor pressure drop in the SCR 30, heat exchanger 40 and direct contact cooler 41 and the lines connecting them. Preferably, the pressure drop is as small as possible as it is preferred that the pressure in the absorber is as high as possible. The pressure drop from boiler 20 to the absorber 45 is therefore preferably less than 1 bar, and preferably less than 0.5 such as 0.2 to 0.3 bar. This corresponds to a pressure in the absorber from 4.5 to 14.8 bare.

The combination of high pressure and high CO₂ content of the exhaust gas introduced into the absorber makes it possible to reduce the volume of the absorber at the same time as high efficiency CO₂ capture is obtained. Significantly, this also enables the use of industrially proven capture equipment, without scale-up, and the use of hot potassium carbonate absorbent which in contrast to organic absorbents does not degrade by reaction with residual exhaust gas oxygen.

The aqueous absorbent used in the absorber may be an amine solution, an amino acid solution, an ammonium carbonate solution or, preferably, an oxygen tolerant hot aqueous potassium carbonate based solution. Preferably the hot aqueous potassium carbonate based solution comprises from 15 to 35% by weight of K₂CO₃ dissolved in water. Appropriate additives may be used to increase reaction rates and to minimize corrosion. Potassium carbonate based absorbent, with inorganic additives, are preferred as absorbent due to zero volatility and excellent chemical stability, in particular in the CO2 absorber which treats flue gas with high partial pressure of oxygen. Oxygen will degrade alternative absorbents, such as virtually all organic aqueous solutions including amines, amino acids etc, at the concentrations and the temperatures of the absorber and desorber. Degradation of the absorbent will add several problems and cost elements to the operations of the plant, including additional cost of separating degraded absorbent form the bulk of the absorbent, replacing degraded absorbent and waste handling. Degradation of absorbent may also give gaseous degradation products that may be discharged together with the CO₂ depleted exhaust gas. Some of these emissions will be toxic and environmentally unacceptable.

In hot potassium carbonate based systems CO₂ is absorbed according to the following overall reversible reaction:

K₂CO₃+CO₂+H₂O<-->2 KHCO₃−ΔHrl=−32.29 kJ/mol CO2) (1)

Lean exhaust gas is withdrawn at the top of the absorber 45 through a lean exhaust gas line 49 and is introduced into a washing section 50 where the lean exhaust gas is brought in countercurrent flow against washing water in a contact section 51. Washing water is collected at the bottom of the washing section through a washing water recycle line 52 and is re-introduced into the washing section above the contact section 51. Cooling in line 52 may condense water vapour from the exhaust gas, and thus preserve water. Alternatively, heating will vaporize water, increasing the heat capacity and volume of the lean exhaust gas, and thus increasing the power produced in expander 54. Heating may be accomplished by introducing hot water from countercurrent scrubber 41 to the top of countercurrent scrubber 50, by re-directing circulation line 42 to the top of countercurrent scrubber 50, and returning the water to countercurrent scrubber 41 via line 52 which is then connected to the top of countercurrent scrubber 41. Washed lean exhaust gas is withdrawn from the top of the washing section through a treated exhaust pipe 53.

The gas in the treated exhaust pipe 53 is introduced into the heat exchanger 40 where the treated exhaust gas is heated against the hot exhaust gas leaving the SCR 30.

The thus heated and treated exhaust gas is then introduced into a gas turbine 54 where the gas is expanded to produce electrical power in a generator 55. Expanded gas is withdrawn through an expanded exhaust gas pipe 56 and is released into the atmosphere. The skilled person will understand that residual heat in the expanded gas may be used in the steam cycle such as pre-heating of boiler water in line 28, for the production of additional steam to the steam turbine, or for heating water flowing to the top of countercurrent scrubber 50.

Rich absorbent, i.e. absorbent laden with CO₂ is collected at the bottom of the absorber 45 and is withdrawn there from through the rich absorbent pipe 48, as described above.

An oxygen reduction unit 73 is preferably arranged in the rich absorbent line 48 to remove or substantially reduce the oxygen content of the rich absorbent before introduction into stripping column 61. The oxygen reduction unit is provided to reduce the oxygen content of the rich absorbent to avoid an oxygen content in the captured CO₂ that is too high for the intended use of the CO₂. In most oil fields, CO₂ having a too high oxygen content will not be accepted for enhanced oil recovery (EOR), which at short term will be the most probable large scale use for captured CO₂.

The oxygen reduction unit may be a flash tank, where oxygen is removed from the rich absorbent by flashing over a pressure reduction valve 72. More preferably, the oxygen reduction unit 73 is a stripping unit where oxygen is removed by means of a stripping gas, most preferably nitrogen, but other inert gases such as CO₂, may also be used

The pressure in the oxygen reduction unit 73 is lower than the pressure in the absorber 46 to release oxygen. The pressure in the oxygen removal unit is, however, higher than the partial pressure of CO₂ in the exhaust gas introduced into the absorber through line 44, to avoid that a substantial part of the CO₂ in the rich absorbent is stripped of together with the oxygen. Typically, the pressure in the oxygen reduction unit is between 2 and 3 bara. The stripped of oxygen and any stripping gas is withdrawn through a stripper line 74 for further treatment.

The rich absorbent leaving the oxygen removal unit 73 is thereafter flashed over a flash valve 60 to a pressure slightly above 1 bara, such as 1.2 bara, before being introduced into a stripping column 61.

One or more contact section(s) 62 is/are arranged in the stripping column 61. The rich absorbent is introduced above the upper contact section of the stripper, and countercurrent to steam introduced below the lowest contact section. Low partial pressure of CO₂ in the stripper, which is the result of low pressure and dilution of CO₂ in the stripper, causes the equilibrium in the reaction (1) above to be shifted towards left and CO₂ to be released from the absorbent.

Lean absorbent is collected at the bottom of the stripping column 61 and is withdrawn through a lean absorbent pipe 63. The lean absorbent pipe 63 is split in two, a lean absorbent reboiler pipe 64 that is heated in a reboiler 66 to give steam that is introduced as stripping gas into the stripping column through a steam line 67, and a lean absorbent recycle line 65 in which lean absorbent is recycled into the absorber 45.

A flash valve 68 followed by a flash tank 69 is provided in the lean absorbent recycle line 65 to flash the lean absorbent. The gaseous phase is withdrawn from the flash tank 69 by means of a compressor 70. The compressed and thus heated gaseous phase is introduced into the stripping column 61 as additional stripping steam. The liquid phase in the stripping tank 69 is withdrawn and pumped by means of a pump 71 to boost the pressure thereof before the liquid phase is introduced into the absorber 45 via line 47 as lean absorbent.

A washing section comprising a contact section 80 and a collector plate 81 arranged below the washing section is arranged at the top section of the stripping column 61. Gas leaving the top of the (upper) contact section 62 flows through the collector plate and through the contact section 80 before being withdrawn through a CO₂ withdrawal pipe 82 at the top of the stripping column 61.

Washing and cooling water is introduced over the washing section 80 through a washing water line 83 and is caused to flow countercurrent to the upstreaming CO₂ and water vapour mixture from the contact section(s) 62 for removal of any absorbent or other impurities in the gas and for condensing water vapour, thus heating the water. The water is withdrawn from the collector plate 81 through a wash water return line 84. A circulation pump 85 is provided in line 84 to boost the pressure and facilitate the flow of the heated water before it is flashed in a flash valve 86 and introduced into a flash tank 87 to be separated in a liquid phase and a gaseous phase. Increased energy content and higher temperature of the water in wash water line 84 will reduce the required power for compressor 90. The wash water in line 84 may therefore be routed to utilize suitable low temperature waste heat after it exits collector plate 81, but before it enters flash valve 86. Such waste heat sources may include intercoolers used in the CO2 compressor train 95, waste heat from intercooler 100 and waste heat from direct contact cooler 41.

The liquid phase in flash tank 87, now cooled by the low pressure flash operation, is withdrawn through a circulation pump 88 and is re-circulated to the washing contact section 80. The gaseous phase is withdrawn through a compressor 90 and thereafter optionally cooled in a cooler 91 and led through a steam line 92 and introduced as additional stripping steam together with the steam in line 67. Together with steam from compressor 70, this supplies most of the steam needed for the operation of the stripping column 61, thus minimizing the duty of reboiler 66 and maximizing the overall system efficiency.

CO₂ and residual steam are collected at the top of the stripping column through a CO₂ withdrawal pipe 82. The steam and CO₂ in pipe 82 is cooled in a cooler 93 and introduced into a flash tank 94. Water is collected in the bottom of the flash tank 94 and is introduced into the water return line 83 as washing water. A water balance pipe 95 may be provided to add or remove water to pipe 83, to balance the circulating amount of water. FIG. 1 shows a relatively simplified and schematic overview of the water balance in this system. In practice, maintaining water balance in the CO₂ system is very important and may be more complex. For example, appropriate amounts of the liquid from flash tank 94 may be routed directly to the top of contact sections 62 in stripping column 61, to the top of contact sections 46 in absorber column 45, and/or to the top of contact section 51 in washing section 50.

The gaseous phase in the flash tank 94 is withdrawn and is compressed by means of a compressor 95 before the gas is further treated to give dry and compressed CO₂ that is exported from the plant for useful applications or for deposition. The skilled man will understand that several compressor stages and a dehydration unit may be needed, depending on the required CO2 purity and delivery pressure.

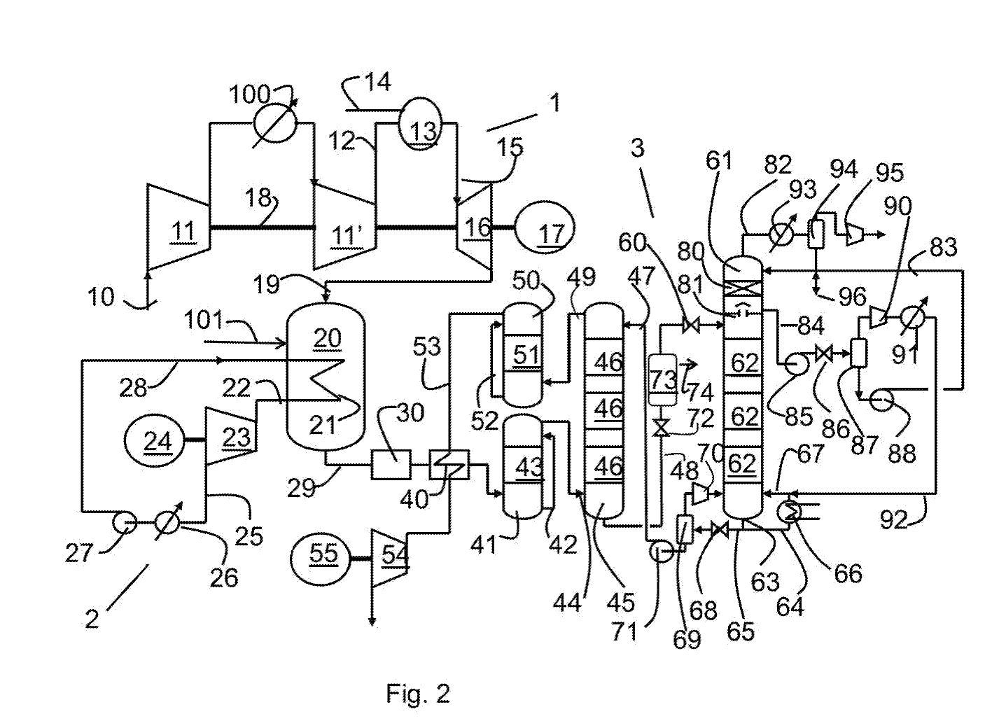

FIG. 2 illustrates an alternative embodiment of the present invention where an optional fuel gas line 101 is provided to supply fuel to the boiler 20, which is modified by introduction of one or more burners. The fuel can be gas, oil, coal, bio or other fuel. The specific boiler design used will depend on the fuel. In the following description, gas fuel is assumed. According to this embodiment, boiler 20 will first cool the flue gas from line 19 to a temperature suitable for extra firing using the fuel gas, by heat exchange with steam coil 21. The gas is cooled to a temperature in the range 350 to 500° C., determined by the requirement for a stable flame when firing the partially oxygen depleted flue gas from line 19, where higher temperature is better, and by the objective to minimize NOx formation, where lower temperature is better. Typically, the flue gas in line 19 contains between 12 and 13% oxygen by volume. After firing with extra fuel gas from line 101, the residual oxygen is reduced to below 6% by volume, preferred below 4% by volume, and even more preferred 3% by volume or less. Energy from this firing is transferred to steam coil 21, thus cooling the flue gas to between 250 and 450° C. This extra firing gives some very important effects. Steam turbine 23 will produce much more energy. The partial pressure of CO₂ in the flue gas from, boiler 20 will increase significantly, greatly simplifying the CO₂ capture in capture system 3. The residual oxygen in the flue gas is much reduced, reducing the amount of oxygen dissolved in the rich CO₂ absorbent from CO₂ absorber 45, and thus limiting the amount of oxygen that escapes into the CO₂ product. Depending on the residual oxygen content in the exhaust gas leaving the boiler 20, and the requirements for the end use of the captured CO₂, the oxygen reduction unit 73 may be omitted. Additionally, the amount of water vapour in the flue gas from boiler 20 increases, increasing the water condensation temperature in the flue gas, and thus increasing the amount and temperature of the energy available from cooler 41.

The skilled man will also understand that the key principle of the complete process is to enable high temperature and therefore efficient power production, systems 1 and 2, in combination with pressurized exhaust gas purification, system 3, without re-compression of exhaust gas, fuel conversion or air separation. Pressurized exhaust gas purification enables the use of hot potassium carbonate based absorbent, but will also enable and enhance other CO₂ capture methods such as amines, amino acids, ammonium carbonate, membranes or dry CO₂ absorbent based systems.

Table 1 below is an illustration on the input and output from an exemplary plant according to the present invention to illustrate the total efficiency obtained by the present solution. Table 1 refers to FIG. 1, without extra firing in boiler 20 from a fuel gas line 101.

TABLE 1

| Variable | Unit | Comment | Numerical |
|---|---|---|---|
| Fuel gas flow | kg/s | — | 4.57 |
| Fuel gas HHV | kJ/kg | Higher heating value, includes condensation heat | 53140 |
| | | of water vapor formed in combustion | |
| Fuel gas LHV | kJ/kg | Lower heating value excluding condensation heat | 48260 |
| | | of water vapor formed in combustion | |
| Firing rate | MW | Gas turbine combustor, 12.4 mole % oxygen in flue | 242.8 |
| HHV | | gas. | |
| Firing rate | MW | Gas turbine combustor, 12.4 mole % oxygen in flue | 220.6 |
| LHV | | gas. | |
| Gas turbine air | MW | Gas turbine air compressor. | 115 |
| compr. duty | | | |
| Gas turbine | MW | Expanding flue gas from combustor. | 115 |
| expander | | | |
| Expander 54 | MW | Expanding purified flue gas | 45.8 |
| Steam turbine | MW | Steam turbine parameters 180 bara 565° C. reheat | 73.3 |
| power | | to 565° C., adiabatic efficiency 92% | |
| Gross el | MW | Expanders and steam turbine minus gas turbine | 118.8 |
| production | | compressor | |
| Power plant | MW | 4% of steam turbine power | 2.9 |
| parasitic | | | |
| CO2 plant | MW | Includes pumps and heat pumps | 3.3 |
| parasitic | | | |
| CO2 | MW | Compressing about 11.7 kg/s CO2 (90% capture | 4.4 |
| compressor | | rate) from 1.0 bara to 100 bara, adiabatic | |
| parasitic | | efficiency 80% | |
| Power plant | MW | Gross el power minus parasitic | 108.2 |
| net el | | | |
| production | | | |
| Efficiency | % | Net el production divided by HHV firing rate | 44.5 |
| HHV | | | |
| Efficiency LHV | % | Net el production divided by LHV firing rate | 49.0 |

Table 2 below shows the feed gas to the CO₂ absorber for the exemplary plant shown in Table 1. Note the partial pressure of CO₂ which is about 0.3 bare. Although much higher than for gas turbine flue gas at atmospheric pressure, this is relatively low for hot potassium carbonate based CO₂ capture, where partial pressure of 0.5 bara or higher is preferred. Such low partial pressure may result in somewhat lower CO₂ capture rate than the desired 90%. Note also the actual volume flow of gas which is very low for a 108 MW system, enabling the use of a relatively small diameter CO₂ capture column.

TABLE 2

| Variable | Unit | Value |
|---|---|---|
| Pressure | bara | 8.0 |
| Temperature | ° C. | 92 |
| Mass flow | kg/s | 216.5 |
| Actual volume flow | m3/s | 28.9 |
| H₂O | mole fraction | 0.097364 |
| N₂ | mole fraction | 0.732313 |
| Ar | mole fraction | 0.008720 |
| O₂ | mole fraction | 0.124829 |
| CO₂ | mole fraction | 0.036775 |

Table 3 below is an illustration of the input and output from an exemplary plant according to the present invention to illustrate the total efficiency obtained by the present solution. Table 3 refers to FIG. 2, with fuel line 101, which includes extra firing in boiler 20.

TABLE 3

| Variable | Unit | Comment | Numerical |
|---|---|---|---|
| Fuel gas flow | kg/s | Total firing produces 2.5 mole % residual oxygen | 10.90 |
| Fuel gas HHV | kJ/kg | Higher heating value, includes condensation heat | 53140 |
| | | of water vapour formed in combustion | |
| Fuel gas LHV | kJ/kg | Lower heating value excluding condensation heat | 48260 |
| | | of water vapour formed in combustion | |
| Firing rate | MW | Gas turbine combustor plus co-firing, 2.5 mole % | 579.2 |
| HHV | | oxygen in flue gas. | |
| Firing rate | MW | Gas turbine combustor plus co-firing, 2.5 mole % | 526.1 |
| LHV | | oxygen in flue gas. | |
| Gas turbine air | MW | Gas turbine air compressor. | 115 |
| compr. duty | | | |
| Gas turbine | MW | Expanding flue gas from combustor. | 115 |
| expander | | | |
| Expander 54 | MW | Expanding purified flue gas. | 45.5 |
| Steam turbine | MW | Steam turbine parameters 180 bara 600° C. reheat | 230.1 |
| power | | to 600° C., adiabatic efficiency 92% | |
| Gross el | MW | Expanders and steam turbine minus gas turbine | 275.9 |
| production | | compressor (gross el) | |
| Power plant | MW | 4% of steam turbine power | 9.2 |
| parasitic | | | |
| CO₂ plant | MW | Includes pumps and heat pumps | 8.9 |
| parasitic | | | |
| CO₂ | MW | Compressing about 26.6 kg/s CO2 (85% capture | 10.3 |
| compressor | | rate) from 1.0 bara to 100 bara, adiabatic | |
| parasitic | | efficiency 80% | |
| Power plant | MW | Gross el power minus parasitic | 247.5 |
| net el | | | |
| production | | | |
| Efficiency | % | Net el production divided by HHV firing rate | 42.7 |
| HHV | | | |
| Efficiency LHV | % | Net el production divided by LHV firing rate | 47.1 |

Table 4 below shows the feed gas to the CO₂ absorber for the exemplary plant shown in Table 3. Note the partial pressure of CO₂ which is about 0.7 bara. This is within the normal range for hot potassium carbonate based CO₂ capture, where partial pressure of 0.5 bara or higher is preferred. Note also the actual volume flow of gas which is about the same as in Table 2, although the power production is more than doubled. The thermal efficiency, which is very high in Table 1, with both CO₂ capture and compression included, is only slightly reduced with the extra firing. Significantly, the mole fraction of oxygen in the flue gas to the CO₂ absorber is much reduced.

TABLE 4

| Variable | Unit | Value |
|---|---|---|
| Pressure | bara | 8.1 |
| Temperature | ° C. | 98 |
| Mass flow | kg/s | 212 |
| Actual volume flow | m3/s | 28.1 |
| H₂O | mole fraction | 0.120195 |
| N2 | mole fraction | 0.754443 |
| Ar | mole fraction | 0.008981 |
| O2 | mole fraction | 0.026469 |
| CO₂ | mole fraction | 0.089911 |

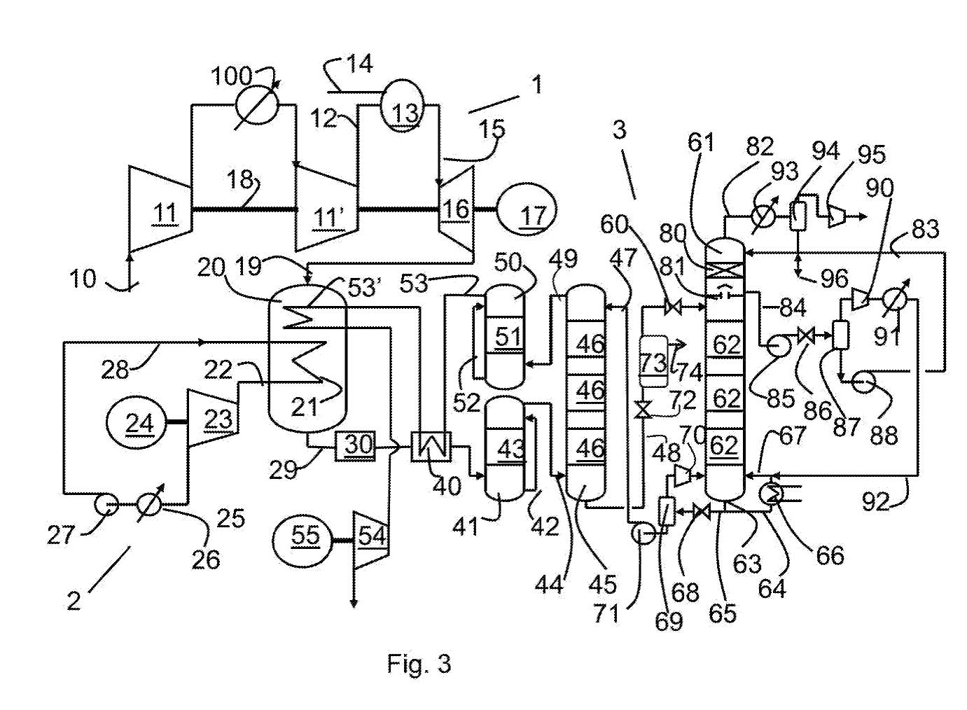

FIG. 3 illustrates an embodiment based on the embodiment of FIG. 1, where the gas in the treated exhaust pipe 53 after being heated in the heat exchanger 40, is further heated in heating coils 53 provided in the boiler 20, before the gas is expanded over the turbine 54. This additional heating of the CO₂ lean exhaust gas increases the output from the turbine 54 with connected generator 55.

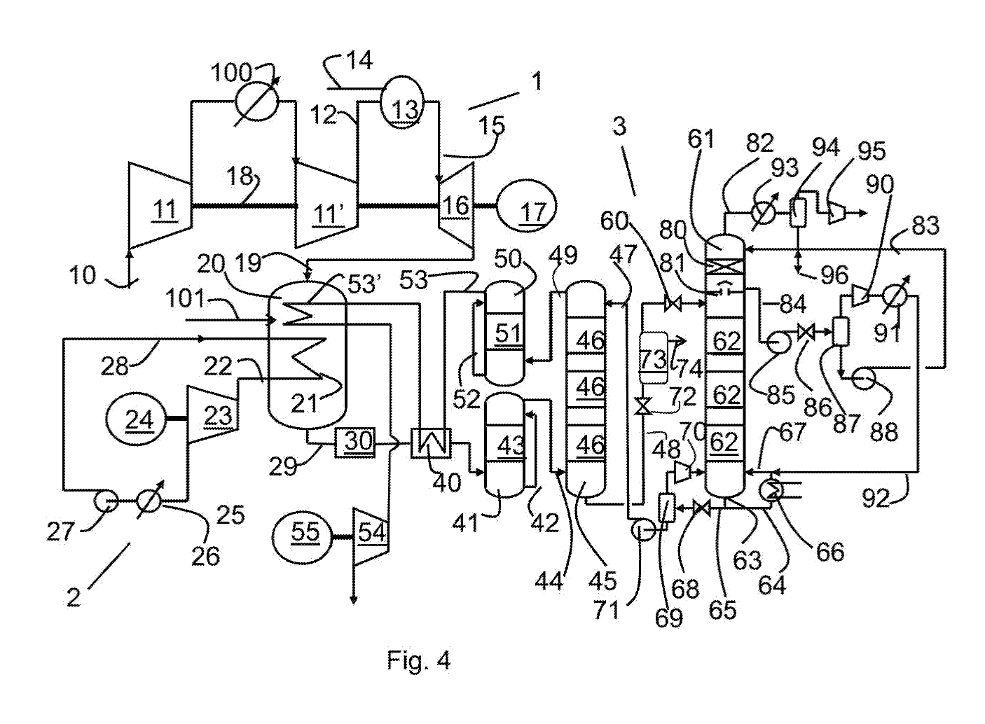

FIG. 4 illustrates still a different embodiment of the present invention, where both the additional features of the embodiments of FIGS. 2 and 3 are included. Additional fuel is introduced into the boiler 20 via a fuel line 101, as described for FIG. 2. Additionally, a heat coil 53′ as described with reference to FIG. 3, is provided to further heat the CO₂ lean exhaust gas before expansion over turbine 53.

1. A method for producing electrical power and capture CO₂, comprising the steps of:
a. introducing gaseous fuel and an oxygen containing gas into a gas turbine to produce electrical power and an exhaust gas;
b. cooling the exhaust gas withdrawn from the gas turbine by production of steam in a boiler;
c. introducing the cooled exhaust gas from step b) into a CO₂ capture plant for capturing CO₂ from the cooled exhaust gas by an absorption/desorption process, to give a CO₂ rich stream that is treated further to give CO₂ that is exported, and a treated CO₂ lean exhaust gas; and
d. releasing the treated CO₂ lean exhaust gas into the surroundings and the captured CO₂ is exported from the plant, wherein the exhaust gas leaving the gas turbine in step a) has a pressure of 3 to 15 bara, and that the treated CO₂ lean exhaust gas from step c) is re-heated and expanded to atmospheric pressure before being released into the surroundings in step d).

2. The method according to claim 1, wherein additional fuel gas is introduced into the boiler in step b) to give extra firing in the boiler.

3. The method according to claim 1, wherein NOx in the exhaust gas is removed or substantially reduced after the exhaust gas is leaving the boiler in step b) and before introduction into the absorber in the CO₂ capture plant in step c).

4. The method according to claim 3, wherein NOx is removed by means of selective catalytic reduction.

5. The method according to claim 1, wherein the exhaust gas leaving the boiler is further cooled by heat exchanging against CO₂ lean exhaust gas leaving the absorber, and wherein the CO₂ lean exhaust gas thereafter is expanded over a turbine.

6. The method according to claim 5, wherein the CO₂ lean exhaust gas being heated by heat exchange against the exhaust gas leaving the boiler, is further heated in a heat coil inserted into the boiler, before being expanded.

7. (canceled)

8. A combined cycle power plant with CO₂ capture, comprising a gas turbine, a boiler for cooling of the exhaust gas leaving the gas turbine by generation of steam in heat tubes, a steam turbine cycle to produce electric power from the steam generated in the boiler, and a CO₂ capture plant comprising an absorber adopted to bring an aqueous absorbent in countercurrent flow to the exhaust gas to give CO₂ lean exhaust gas and a CO₂ rich absorbent, a lean exhaust line for withdrawal of the lean exhaust gas from the absorber, a rich absorbent line for withdrawing rich absorbent from the absorber and introducing the rich absorbent into a stripper for regeneration of the absorbent, a CO₂ withdrawal line for withdrawal of a CO₂ rich stream from the stripper, and a lean absorbent line for withdrawing regenerated, or lean, absorbent from the stripper and introducing the lean absorbent into the absorber, wherein the gas turbine is configured for partial expansion of the exhaust gas to a pressure of 3 to 15 bara, and wherein a turbine for expanding the exhaust gas to atmospheric pressure is arranged downstream of the absorber for expanding of the exhaust gas after capture of the CO₂.

9. The plant according to claim 8, wherein an extra fuel line is provided to deliver additional fuel to a burner in the boiler for adding temperature to the exhaust gas therein.

10. The plant according to claim 8, wherein a selective catalytic reduction unit is arranged to remove NOx from the cooled exhaust gas withdrawn from the boiler.

11. The plant according to claim 8, wherein a heat exchanger is arranged to cool the exhaust gas before introduction into the absorber against CO₂ lean exhaust gas withdrawn from the absorber before the lean exhaust gas is introduced into the turbine.

12. The plant according to claim 11, wherein a heat coil is inserted into the boiler for further heating of the CO₂ lean exhaust gas leaving the heat exchanger.

13. (canceled)

14. The method according to claim 1, wherein the pressure of the exhaust gas leaving the gas turbine has a pressure of 6 to 12 bara.
